(19) United States
(12) Patent Application Publication
(10) Pub. No.: US 2026/0368421 A1
(43) Pub. Date: Nov. 19, 2026

(54) GENERATIVE ARTIFICIAL INTELLIGENCE POWERED FORMLESS COMMUNICATION WITH A VIRTUAL ROBOT

(71) Applicant: Freshworks Inc., San Mateo, CA (US)

(72) Inventors: Keshav SHRIKANT, Bengaluru (IN); Shwet Kamal MISHRA, Bengaluru (IN); Arrman Anicket SAHA, Mumbai (IN); Harsh SOMANI, Bengaluru (IN); Rudresh VEERABHADRAIAH, Bengaluru (IN)

(73) Assignee: Freshworks Inc., San Mateo, CA (US)

(21) Appl. No.: 19/208,465

(22) Filed: May 14, 2025

(51) Int. Cl. G06F 40/174; G06F 16/3329; G06F 40/205

(52) U.S. Cl. CPC G06F 40/174; G06F 16/33295; G06F 40/205

(57) ABSTRACT

One or more non-transitory computer-readable media storing one or more computer programs, which is configured to cause at least one processor to identifying if a query submitted by a user is associated with an ongoing conversation with a robot via a communication medium, identifying one or more relevant service items for the user, and pre-filling the one or more relevant service items in a service item form based on the identified one or more relevant service items. The one or more computer programs is also configured to cause at least one processor to communicating with the user to complete the service item form by way of automation for one or more fields that are incomplete, and requesting confirmation from the user for one or more values entered in the one or more fields by way of the automation, and identifying when the user wants to exit form filling.

### FIELD

The present invention generally relates to artificial intelligence (AI), and more specifically, to a system for providing a generative AI formless conversations in virtual robot (or agent).

### BACKGROUND

A virtual agent (or robot) is a state-of-the-art AI-machine learning (ML) powered self-serve feature launched by Freshservice®, where users can interact with a Slack®/Teams® integrated service robot to identify the most relevant solution articles/services to get their respective queries addressed or resolved.

Virtual robots use the best-in-class search and intent detection algorithms to identify the top three (3) relevant solution articles and service items, given the user's query. See, for example, FIG. 1, which is a graphical user image (GUI) 100 illustrating a user experience. In FIG. 1, the users/requesters identify the most relevant article/service request without having to navigate through a knowledge base/support portal.

However, it should be noted that there are several issues and/or problems to be addressed for the service request flow. For example, users need to review all the service items to identify the single most relevant service item. The forms are not self-explanatory, and the users still need to fill in the service item form on the portal.

It should be appreciated that the virtual robot follows a single turn request response flow whereas an actual agent would be able to have a conversation with the user so that the suggestions are more relatable and relevant. Virtual robots do not facilitate this interaction. Further, a virtual robot is not contextual, e.g., if the user asks for a service item for leave request, the following service items suggestions may be presented
Leave Request—2021
Leave Request—2022
Leave Request—2023

Clearly, the first suggestion is not relevant if the query is coming in the year 2023.

The virtual robot in this example is not truly conversational in the sense that a lot of inputs the virtual robot receives depend on the user clicking on buttons in Slack®/Teams®, which leads to inaccuracies.

FIG. 2 is a system diagram 200 illustrating related art of a conversational bot. In system diagram 200, the virtual robot is designed along similar principles. First and foremost, the virtual robot understands the user's query and determines which set of actions to perform. These actions range from responding to the user in natural language format to searching the database for an item. In some cases, the virtual robot may connect the user with a human agent if the query is difficult to understand. For example, if the user requests access to a software package, the virtual robot understands that the user needs an item from the service catalog. The virtual robot may search for the correct item and present it. By default, these conversations are single in nature, but the user can respond in multiple ways. For instance, the user may want additional clarity on the items presented or pose a different question altogether.

The virtual robot, typical to any state-of-the-art robot, may find it difficult to understand a change in context. The virtual robot, in some additional cases, may be limited to access within the knowledge base and may respond via pre-set templates. All these limitations may lead to the user not experiencing formless conversation with a virtual robot.

In order to mitigate such issues, the robot has to be supplied with labeled data, domain knowledge and engineering resources. However, with the advent of ChatGPT^{TM}, processes related to building a conversation robot have been democratized. For example, additional knowledge is incorporated into the virtual robot thereby enhancing its reasoning and conversational capabilities. This has made it far more accurate by leveraging GPT 3.5 turbo model's excellent language understanding capability.

Accordingly, an improved and/or alternative approach to elevate communication via a messaging platform for such technologies may be beneficial.

### SUMMARY

Certain embodiments of the present invention may provide solutions to the problems and needs in the art that have not yet been fully identified, appreciated, or solved by current AI technologies. For example, some embodiments of the present invention pertain to a system that provides a generative AI formless conversations with a virtual robot on a communication platform.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a GUI illustrating a user experience.

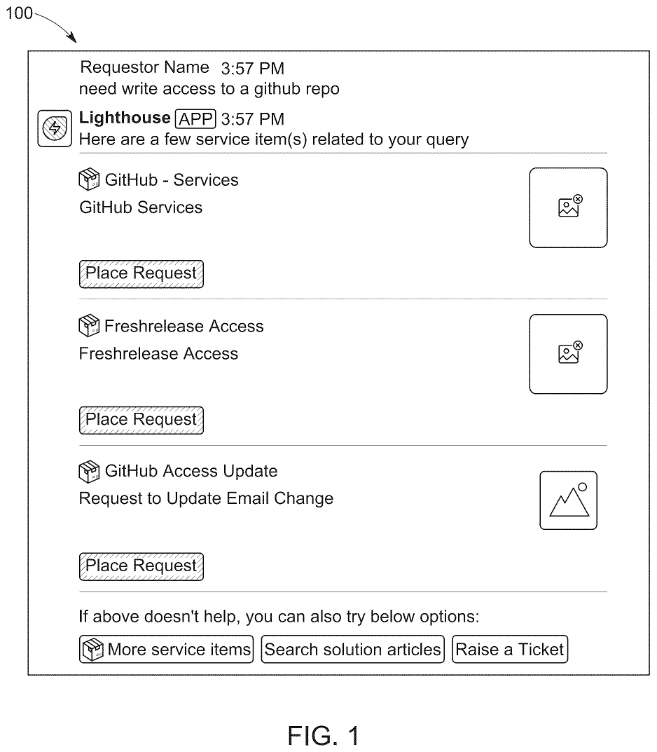

FIG. 2 is a system diagram illustrating related art of a conversational bot.

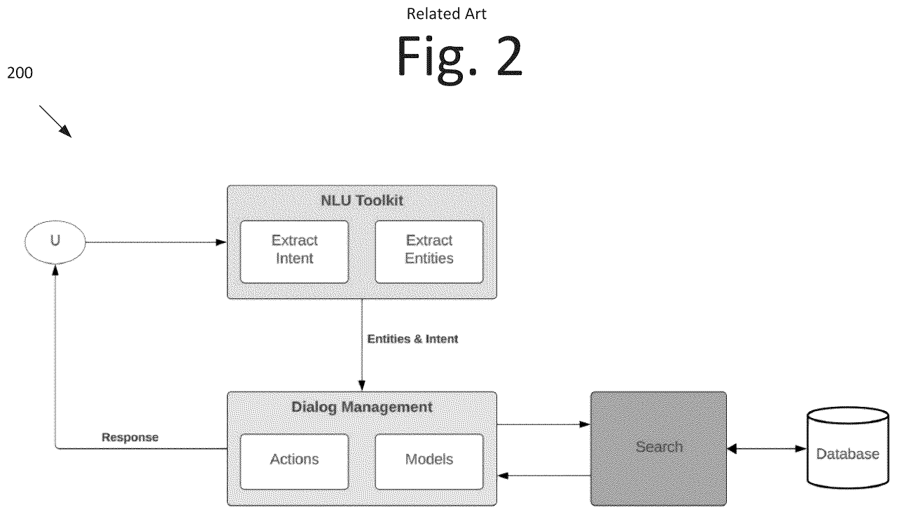

FIG. 3 is a GUI illustrating an elevated virtual robot flow, according to an embodiment of the present invention.

FIG. 4 is a system architecture illustrating generative AI formless conversations with a virtual robot, according to an embodiment of the present invention.

FIG. 5 is a flow diagram illustrating method for determining/identifying if the user's conversation with a robot is an ongoing communication, according to an embodiment of the present invention.

FIG. 6 is a flow diagram illustrating method for identifying the most relevant service item for the user, according to an embodiment of present invention.

FIG. 7 is a flow diagram illustrating method for pre-filling the service item form using information gathered during the relevance stage.

FIG. 8 is a flow diagram illustrating a method for engaging conversationally (i.e., formless conversations) with the user to fill the form, according to an embodiment of the present invention.

FIG. 9 is a flow diagram illustrating a method for requesting for the user's confirmation on values, which were filled in the form, and if the user wants to edit the form, according to an embodiment of the present invention.

FIG. 10 is an architectural diagram illustrating a computing system configured to perform label biasing of data associated with closed deals using interpolation, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to a system that provides a generative AI formless conversations with a virtual robot on a communication platform.

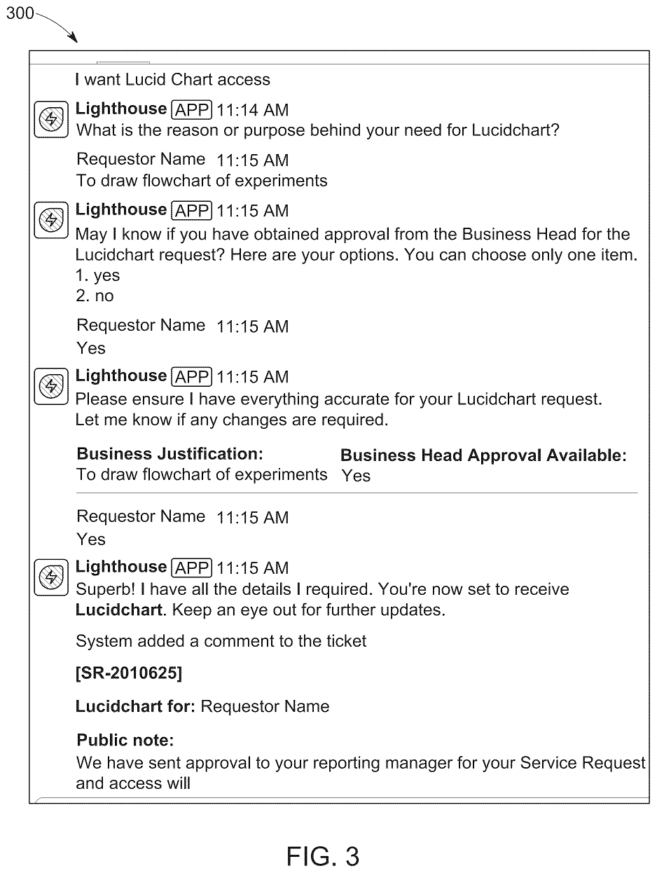

FIG. 3 is a GUI 300 illustrating an elevated virtual robot flow, according to an embodiment of the present invention. In this example, GUI 300 depicts a communication between a user (e.g., employee) and a bot. More specifically, in this example, the user requests for a service item conversationally with the bot without recognizing that the conversation is with the bot and without realizing that the bot is completing a service item form in the backend of the platform.

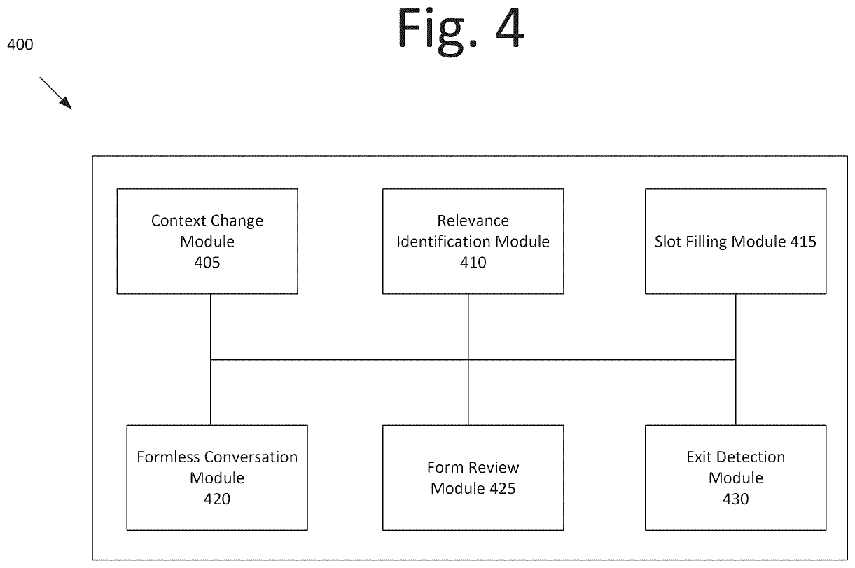

FIG. 4 is a system architecture 400 illustrating generative AI formless conversations with a virtual robot, according to an embodiment of the present invention. In some embodiments, system architecture 400 includes a context change module 405, relevance identification module 410, slot filling module 415, formless conversations module 420, form review module 425, and exit detection module 430. Context change detection module 405 may identify if a user's query is part of the ongoing conversation. Relevance identification module 410 may identify the most relevant service item for the user. Slot filling module 415 may pre-fill the service item form using information gathered during the relevance stage. Formless conversations module 420 may engage conversationally with the user to fill in the form. Form review module 425 may request for the user's confirmation on values which were filled in the form and if they want to edit. Exit detection module 430 may identify if the user wants to exit form filling.

### Context Change Module

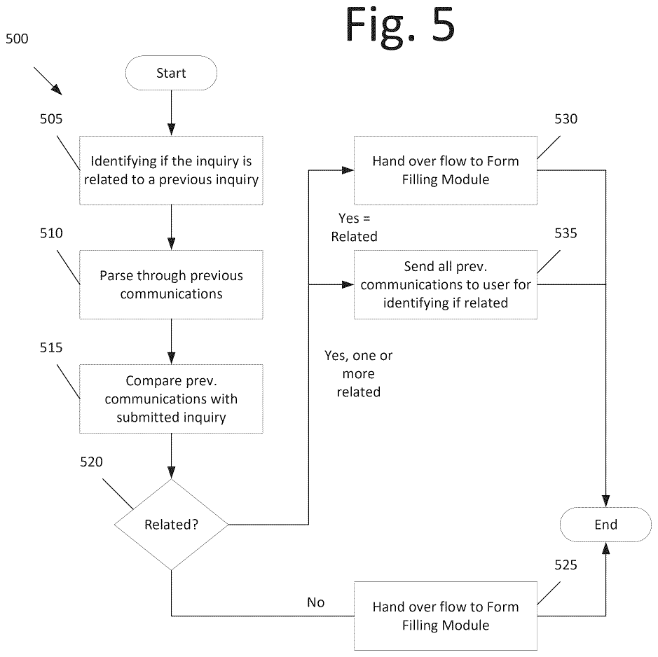

FIG. 5 is a flow diagram illustrating method 500 for determining/identifying if the user's conversation with a robot is an ongoing communication, according to an embodiment of the present invention. In this embodiment, method 500 may be executed by context change module 405 of FIG. 4. Method 500 may begin at 505 with, for every inquiry submitted by the user, identifying whether the inquiry is related to previous communication with the robot. At 510, context change module 405 may parse through previous communications between the user and the robot. At 515, context change module 405 compares the parsed previous communication against the user submitted inquiry. At 520, if the submitted inquiry is not related to any previous communication, context change module 405 may send a response to the user informing the user that a match was not found and ending the previous conversation and a new conversation is started at 525.

If, however, a relevant previous communication was found, then, at 530, context change module 405 may hand over the flow to form filling. In another embodiment, if two or more relevant previous communications are found, then, at 535, context change module displays all relevant previous communications to the user for the user to identify the relevant communications before moving to form filling.

In short, context change module 405 pertains to identify if the inquiry is a continuation of the previous conversation or is a brand new query. In these embodiments, context change is detected when helping the user establish the most relevant service item for the user's inquiry. This inquiry and detection step is necessitated due to the inability/incapability of Teams® for supporting threads in the scope of the application.

Additionally, the user's behavior is anticipated, and the user is allowed to exit from this flow if either the user is unsatisfied with the conversation or the user wants to search for another solution. In these embodiments, ChatGPT is employed with a custom prompt to solve this problem. See discussion below.

### Identifying Relevance Module

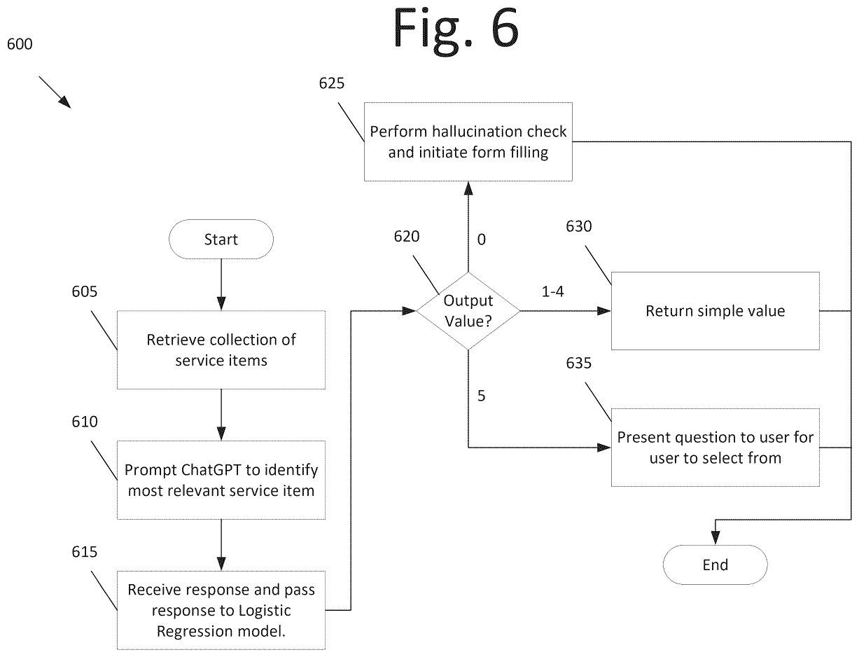

FIG. 6 is a flow diagram illustrating method 600 for identifying the most relevant service item for the user, according to an embodiment of the present invention.

At 605, identifying relevance module 410 may retrieve a collection of service items from a search system. The search system, in some embodiments, retrieves the most relevant service item as the first result with 70 percent accuracy. This is due to the vague nature of queries that the users typically input. For this reason, extra intelligence may be needed to gauge the user's intent and then the most relevant service items are identified.

Continuing with this embodiment, the most relevant service items is found by using ChatGPT™. An example of this is shown in FIG. 3, which is a GUI 300 illustrating an elevated virtual robot flow. Continuing with method 600, at 610, identifying relevance module 410 may prompt ChatGPT^{TM} to identify the most relevant service item given the user's query, and if not, submit follow-up questions to ChatGPT^{TM} to identify the user's intent.

It should be appreciated that anything that the user queries is passed through the relevant identification prompt by way of relevant identification module 410. Relevance identification module 410 may output one or more (up to 6 in this embodiment) values.

In some embodiments, at 615, identifying relevance module 410 may receive the response (i.e., an identification of the relevant service item) from ChatGPT^{TM} (i.e., bot) and pass the response to a Logistic Regression model. Logistic Regression model may be defined as a supervised machine learning algorithm used for classification tasks where the goal is to predict the probability that an instance belongs to a given class or not. The Logistic Regression model in some embodiments may be trained on ChatGPT's responses from this prompt. After ChatGPT's response has been passed to Logistic Regression model, a value may be outputted. For example, a 0 value may be outputted, meaning that the correct service item has been identified, and a slot filling process needs to be started followed by form filling. A value of 1, 2, 3, or 4, means that a response is sent from ChatGPT to the user, and a value of 5 meaning that multiple service items have been identified as relevant. In such an instance, all service items are shown to the user and the user may select the most relevant service item.

Based on the classification from the Logistics Regression model, one of the following steps are performed based on the output value at 620. For example, if a value of 0 is sent (i.e., if ChatGPT^{TM} has found the most relevant service item), a hallucination check is performed, and the slot filling process may begin at 625. Shortly thereafter, the form filling stage is implemented.

At 630, if, however, a value of 1-4 is returned (i.e., multiple conflicting items are found such as “I didn't understand your query”, I could not find a relevant SI”, “I am not equipped to answer”, or “acknowledgement”), a simple response or question is presented to the user with those items and post processing is no longer required. If, however, a value of 5 is received at 635, the user is provided with the relevant service items found, whether it be two, three, or more, at which point the user selects one of the relevant service items.

In another embodiment, the user may have questions about these choices, which may be addressed using two other prompts. For instance, one prompt may be used to understand whether the user has chosen the relevant service item or not. The other prompt may be for the user to respond back appropriately if the user has not selected any relevant service item. If it is anything else apart from these two situations, a raw response from ChatGPT^{TM} is taken and sent back to the user. Using this system, the search system's accuracy is increased to about 92% within just two turns of conversation.

### Slot Filling Module

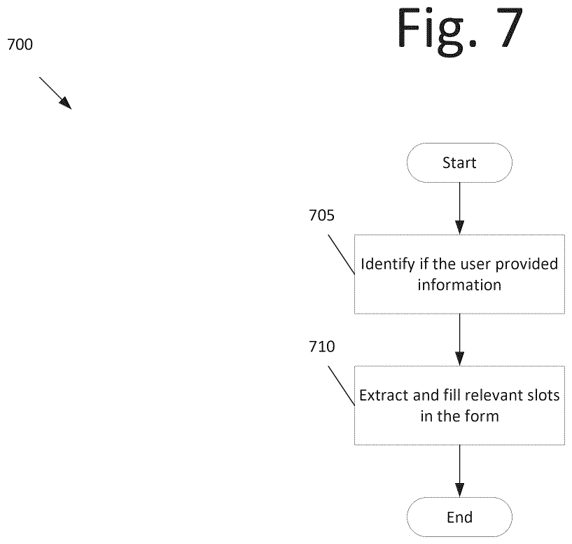

FIG. 7 is a flow diagram illustrating method 700 for pre-filling the service item form using information gathered during the relevance stage. In this embodiment, method 700 is executed by slot filling module 415 of FIG. 4. Under the slot filling module 415, once the most relevant service item is identified, the most relevant service item is pre-filled.

Method 700 may begin at 705 with slot filing module 415 identifying if the user has previously provided any information. This step is performed before asking the user for the values of form fields. It should be appreciated that, once the most relevant service item has been identified, the most relevant service items are pre-filled. Before even asking the user for the values of form fields, the system identifies the user has already provided any information. The system perform this step to avoid asking for any redundant information from the user.

In embodiments where the user has provided information, slot filling module 415 at 710 extracts and fills the relevant slots in the form. This approach avoids asking the user for any redundant information. For example, if the form asks for the name or email ID of the user, this may be redundant information, since the system may already have the name or email ID, because the system database may already contain the user information who is filling in the form.

In certain embodiments, the slot filling capability utilizes ChatGPT™ through a prompt, and also, used for every form field performed for this task. This way, if the form is filled via automation, the form is submitted on behalf of the user and the process moves on to the form review stage. Any form, which is left partially or completely empty, may move on to the form filling stage.

### FORMLESS CONVERSATIONS

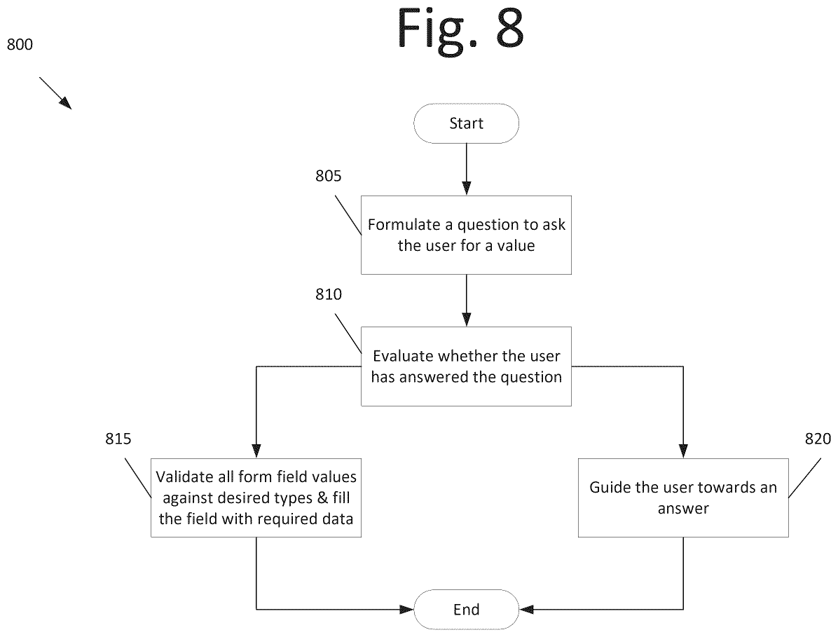

FIG. 8 is a flow diagram illustrating a method 800 for engaging conversationally (i.e., formless conversations) with the user to fill the form, according to an embodiment of the present invention. Method 800 may be executed by formless conversations module 420 of FIG. 4.

In some embodiments, there may be a form, which is either partially or completely empty. In those embodiments, for every form field, whose value is still required, formless conversations module 420 may perform the following method. At 805, formless conversations module 420 may formulate a question to ask the user for the value, and at 810, upon receiving an answer, evaluate whether the user has answered the question. At 815, formless conversations module 420 may, when the user answered the question, validate all form field values against one or more desired types, and fill the field with the required data. Steps 805 through 815 may return to step 805 (i.e., formulate a question) until all fields are completed. Alternatively, at 820, the user is conversed with and the user is guided towards an answer. This step is performed only if the user has not actually answered the question posed. In such an instance, the user is conversed with and guided towards the answer.

In other words, for each field, a question is generated and posed to the user. Upon receiving the user' answer, the intent of the user is identified, i.e., whether the user has answered the question, answer was a follow-up, or not. Depending on the answer, an intelligent response to the answer is provided to guide the user to the guided answer. Once the guided answer is received, the guided answer is extracted and value is filled in the field and next field is addressed. This continues until all fields in the form are complete.

It should be appreciated that the user's input, during this stage, may not go through the context change detection stage. After form filling is completed, the process moves on to the next stage, i.e., form review.

### Form Review

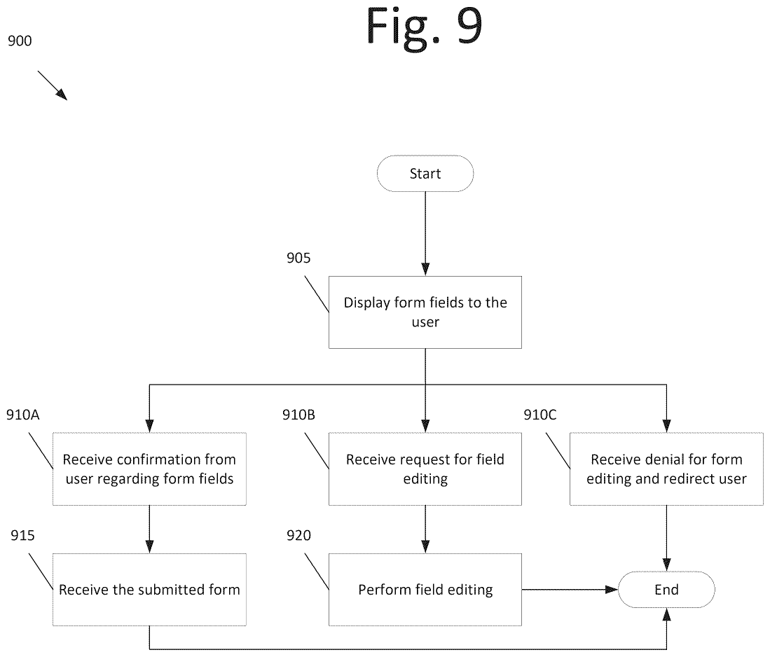

FIG. 9 is a flow diagram illustrating a method 900 for requesting for the user's confirmation on values, which were filled in the form, and if the user wants to edit the form, according to an embodiment of the present invention. In this embodiment, method 900 may be executed by form review module 425 of FIG. 4.

Under the form review module 425, once the form is completed, either during the pre-filling stage or formless conversations stage, the form is submitted on behalf of the user. In some embodiments, as discussed above with respect to FIG. 8, form review module 425 validates all form field values against their desired types. Desired types in some embodiments include dates, numbers, single select drop down, multi-select drop down, and check boxes. In FIG. 9, method 900 may begin at 905 with, once form fields are validated, form review module 425 displays the form fields to user for confirmation. At 910A, the form review module 425 receives confirmation, and 915, upon receipt of confirmation, form review module 425 receives the submitted form and the method ends. At 910B, the form review module may receive a request from the user to edit one or more fields, and at 920, form review module 425 edits the one or more fields are edits and the edited form is resubmitted to the user. This may be a continuous process until the user is satisfied with the form fields. At 910C, if the user denied (i.e., neither confirmed nor requested for edits), form review module 425 redirects the user to a portal with the form pre-populated with values extracted during the conversation.

It should be noted that the user's inputs during this stage do not go through the context change detection stage as well. The conversation with the user is closed after this step, and any query, which is submitted by the user after this stage, is treated as a brand new conversation.

### Exit Detection Module

Under the exit detection module 430, this stage is there to detect whether the user wants to exit the form filling stage or not since context change detection is not employed during the process. In this embodiment, as in context changes, the user is provided with an exit option should they want to exit the application. In certain embodiments, ChatGPT^{TM} is utilized with custom instructions to achieve this. For purposes of explanation, and to provide context, below is a custom instruction.
Task Description:
User is filling the form {form_name}. Identify User Intent to Quit Form Filling Flow. Here is the conversation you have to analyze:
Conversation:
{conversation}
Criteria for Analysis
Explicit Intent to Exit:
   1. If the user explicitly mentions a desire to exit the form filling flow, set the “exit flag” to True.
Implicit Intent to Exit:
1. In cases where the user expresses frustration or negative sentiment without explicitly indicating an intent to exit, also set the “exit flag” to True.
2. In cases where the user's intent is in direct contradiction to what the form

offers, set the “exit flag” to True.
3. In cases where the user's response is unrelated to the assistant's question but not in direct contradiction to what the form offers, set the “exit flag” to False because the implicit intent is NOT TO exit the form filling process.
Contextual Considerations: Take Into Account Various Contextual Cues Such As:
1. Be mindful that mentions of words like “exit” or “quit” in the context of the form are not considered as an intent to exit the form filling flow. Or even if the user denies giving any information or if the user says “no” or “None” or “NA” in response to any field, it should not be considered as an intent to quit the form filling flow.
2. If the user expresses a wish to independently create a ticket or asks to raise a ticket, set the “exit_flag” to True.
3. If the user inquires about your capability to raise a ticket or scolds you or explicitly refuses to raise a request, also set the “exit_flag” to True.
4. If user asks you to ignore the conversation or request then also set “exit_flag” to True. 5. A clear deviation from the form filling flow, DOES NOT suggest an implicit intent to exit the form filling process. Set the “exit_flag” to False in this case.
6. If the user's utterance is a response to the agent, set the “exit flag” to False.

Response Format:
Provide the response in a valid JSON format with the “exit flag” indicating True or False based on the analysis of the user's input, like
{{
“explanation”: “explain your thought process”,
“exit_flag”: True/False
}}

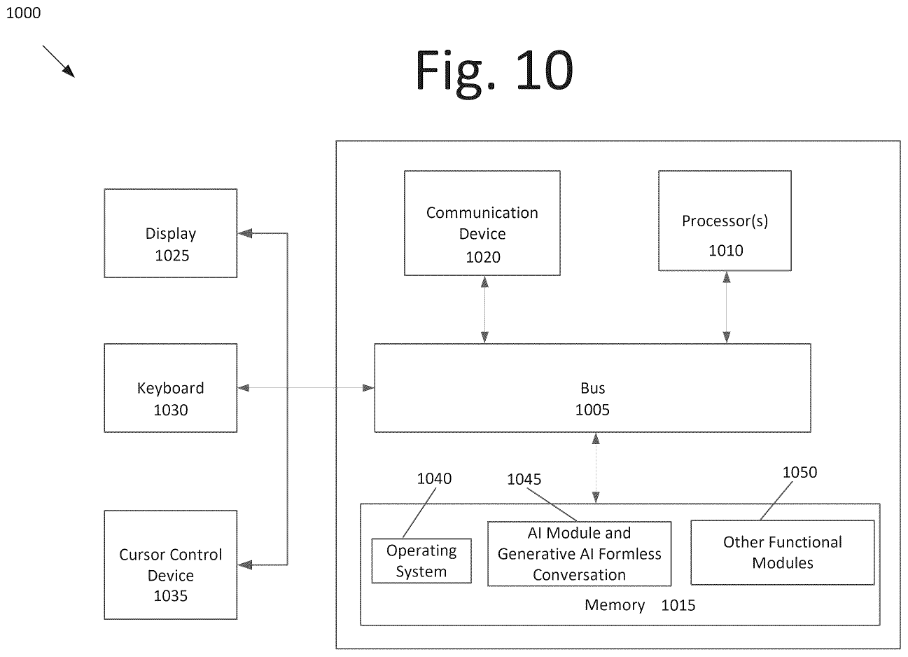

FIG. 10 is an architectural diagram illustrating a computing system 1000 configured to perform label biasing of data associated with closed deals using interpolation, according to an embodiment of the present invention. In some embodiments, computing system 1000 may be one or more of the computing systems depicted and/or described herein. Computing system 1000 includes a bus 1005 or other communication mechanism for communicating information, and processor(s) 1010 coupled to bus 1005 for processing information. Processor(s) 1010 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1010 may also have multiple processing cores, and at least some of the cores may be configured to perform specific functions. Multi-parallel processing may be used in some embodiments. In certain embodiments, at least one of processor(s) 1010 may be a neuromorphic circuit that includes processing elements that mimic biological neurons. In some embodiments, neuromorphic circuits may not require the typical components of a Von Neumann computing architecture.

Computing system 1000 further includes a memory 1015 for storing information and instructions to be executed by processor(s) 1010. Memory 1015 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 1010 and may include volatile media, non-volatile media, or both. The media may also be removable, non-removable, or both. Computing system 1000 includes a communication device 1020, such as a transceiver, to provide access to a communications network via a wireless and/or wired connection. In some embodiments, communication device 1020 may include one or more antennas that are singular, arrayed, phased, switched, beamforming, beamsteering, a combination thereof, and or any other antenna configuration without deviating from the scope of the invention.

Processor(s) 1010 are further coupled via bus 1005 to a display 1025. Any suitable display device and haptic I/O may be used without deviating from the scope of the invention. A keyboard 1030 and a cursor control device 1035, such as a computer mouse, a touchpad, etc., are further coupled to bus 1005 to enable a user to interface with computing system 1000. However, in certain embodiments, a physical keyboard and mouse may not be present, and the user may interact with the device solely through display 1025 and/or a touchpad (not shown). Any type and combination of input devices may be used as a matter of design choice. In certain embodiments, no physical input device and/or display is present. For instance, the user may interact with computing system 1000 remotely via another computing system in communication therewith, or computing system 1000 may operate autonomously.

Memory 1015 stores software modules that provide functionality when executed by processor(s) 1010. The modules include an operating system 1040 for computing system 1000. The modules further include an AI module and generative AI formless conversations 1045 that is configured to perform all or part of the AI/ML processes described herein or derivatives thereof. Computing system 1000 may include one or more additional functional modules 1050 that include additional functionality.

One skilled in the art will appreciate that a “system” could be embodied as a server, an embedded computing system, a personal computer, a console, a smart watch, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

Various types of AI/ML models may be trained and deployed without deviating from the scope of the invention. See, for example, FIGS. 5-9.

The process steps performed in FIGS. 5-9 may be performed by a computer program, encoding instructions for the processor(s) to perform at least part of the process(es) described in FIGS. 5-9, in accordance with embodiments of the present invention. The computer program may be embodied on a non-transitory computer-readable medium. The computer-readable medium may be, but is not limited to, a hard disk drive, a flash device, RAM, tape, and/or any other such medium or combination of media used to store data. The computer program may include encoded instructions for controlling processor(s) of a computing system (e.g., processor(s) 1010 of computing system 1000 of FIG. 10) to implement all or part of the process steps described in FIGS. 5-9, which may also be stored on the computer-readable medium.

The computer program can be implemented in hardware, software, or hybrid implementation. The computer program can be composed of modules that are in operative communication with one another, and which are designed to pass information or instructions to display. The computer program can be configured to operate on a general-purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable media storing one or more computer programs, the one or more computer programs configured to cause at least one processor to:
identifying if a query submitted by a user is associated with an ongoing conversation with a robot via a communication medium;
identifying one or more relevant service items for the user;
pre-filling the one or more relevant service items in a service item form based on the identified one or more relevant service items;
communicating with the user to complete the service item form by way of automation for one or more fields that are incomplete; and
requesting confirmation from the user for one or more values entered in the one or more fields by way of the automation; and
identifying when the user wants to exit form filling.

2. The one or more non-transitory computer-readable media of claim 1, wherein the one or more computer programs are further configured to cause at least one processor to:
for every inquiry submitted by the user, identifying whether the inquiry is related to one or more previous communications with the robot;
parsing through the one or more previous communications between the user and the robot;
comparing the parsed previous communications against the user submitted inquiry;
creating a new conversation when the submitted inquiry is unrelated to any previous communication; or
continuing a same conversation when the previous communication relevant to the user inquiry is found.

3. The one or more non-transitory computer-readable media of claim 1, wherein the one or more computer programs are further configured to cause at least one processor to:
retrieving a collection of service items from a search system;
prompting a relevance identification module to identify a relevant service item based on the user inquiry or submit follow-up questions to the user to identify the user's intent of the user inquiry;
based on the response received from identification module, passing the received response to a Logistic Regression model to output a value;
based on the outputted value, performing slot filling of one or more form fields in the service item form, submit a simple response to the user prompting termination of the service item form filling, or submit two or more relevant service items for the user to select from in order to complete the service item form filling.

4. The one or more non-transitory computer-readable media of claim 1, wherein the one or more computer programs are further configured to cause at least one processor to:
identifying when the user has previously provided any information related to the relevant service item; and
completing or inserting in values associated with the service items in one or more form fields of the service item form prior to requesting the user to insert one or more values into one or more form fields.

5. The one or more non-transitory computer-readable media of claim 1, wherein the one or more computer programs are further configured to cause at least one processor to:
continuously conversing or communicating with the user until the user is guided towards an answer, wherein the continuously conversing or communicating comprises
upon receiving an answer from the user, evaluating whether the user has answered the inquiry, and
when the user answered a question, validating one or more form field values against one or more desired types, and filing the one or more form fields with required data.

6. The one or more non-transitory computer-readable media of claim 1, wherein the one or more computer programs are further configured to cause at least one processor to:
validating one or more values in the one or more form fields against one or more desired types;
once the one or more form fields are validated, displaying the one or more form fields to the user for confirmation;
upon confirmation receipt, submitting the form; or
receiving a request from the user to edit the one or more form fields, and
when the user denied the validation, redirecting the user to a portal with the form pre-populated with values extracted during the conversation.

7. The one or more non-transitory computer-readable media of claim 1, wherein the one or more computer programs are further configured to cause at least one processor to:
editing the one or more fields are edits and the edited form is resubmitted to the user.

8. A computer-implemented method for executing formless communication using a virtual robot, comprising:
identifying, by at least one processor, if a query submitted by a user is associated with an ongoing conversation with the robot via a communication medium;
identifying, by at least one processor, one or more relevant service items for the user;
pre-filling, by at least one processor, the one or more relevant service items in a service item form based on the identified one or more relevant service items;
communicating, by at least one processor, with the user to complete the service item form by way of automation for one or more fields that are incomplete; and
requesting, by at least one processor, confirmation from the user for one or more values entered in the one or more fields by way of the automation; and
identifying, by at least one processor, when the user wants to exit form filling.

9. The computer-implemented method of claim 8, further comprising:
for every inquiry submitted by the user, identifying, by at least one processor, whether the inquiry is related to one or more previous communications with the robot;
parsing, by at least one processor, through the one or more previous communications between the user and the robot;
comparing, by at least one processor, the parsed previous communications against the user submitted inquiry; or
creating, by at least one processor, a new conversation when the submitted inquiry is unrelated to any previous communication;
continuing, by at least one processor, a same conversation when the previous communication relevant to the user inquiry is found.

10. The computer-implemented method of claim 8, further comprising:
retrieving, by at least one processor, a collection of service items from a search system;
prompting, by at least one processor, a relevance identification module to identify a relevant service item based on the user inquiry or submit follow-up questions to the user to identify the user's intent of the user inquiry;
based on the response received from identification module, passing, by at least one processor, the received response to a Logistic Regression model to output a value;
based on the outputted value, performing, by at least one processor, slot filling of one or more form fields in the service item form or submit a simple response to the user prompting termination of the service item form filling, or submit two or more relevant service items for the user to select from in order to complete the service item form filling.

11. The computer-implemented method of claim 8, further comprising:
identifying, by at least one processor, when the user has previously provided any information related to the relevant service item; and
completing or inserting, by at least one processor, in values associated with the service items in one or more form fields of the service item form prior to requesting the user to insert one or more values into one or more form fields.

12. The computer-implemented method of claim 8, further comprising:
continuously, by at least one processor, conversing or communicating with the user until the user is guided towards an answer, wherein the continuously conversing or communicating comprises
upon receiving an answer from the user, evaluating whether the user has answered the inquiry, and
when the user answered a question, validating, by at least one processor, one or more form field values against one or more desired types, and filing the one or more form fields with required data.

13. The computer-implemented method of claim 8, further comprising:
validating, by at least one processor, one or more values in the one or more form fields against one or more desired types;
once the one or more form fields are validated, displaying, by at least one processor, the one or more form fields to the user for confirmation; and
upon confirmation receipt, receiving, by at least one processor, the submitted form,
receiving, by at least one processor, a request from the user to edit the one or more form fields, or when the user denied the validation, redirecting, by at least one processor, the user to a portal with the form pre-populated with values extracted during the conversation.

14. The computer-implemented method of claim 8, further comprising:
editing, by at least one processor, the one or more fields are edits and the edited form is resubmitted to the user.

15. A system configured to perform generative formless conversations using a virtual robot, comprising:
memory comprising a set of instructions; and
at least one processor, wherein the set of instructions are configured to cause the at least one processor to execute:
identifying if a query submitted by a user is associated with an ongoing conversation with the robot via a communication medium;
identifying one or more relevant service items for the user;
pre-filling the one or more relevant service items in a service item form based on the identified one or more relevant service items;
communicating with the user to complete the service item form by way of automation for one or more fields that are incomplete; and
requesting confirmation from the user for one or more values entered in the one or more fields by way of the automation; and
identifying when the user wants to exit form filling.

16. The system of claim 15, wherein the set of instructions are further configured to cause the at least one processor to execute:
for every inquiry submitted by the user, identifying whether the inquiry is related to one or more previous communications with the robot;
parsing through the one or more previous communications between the user and the robot;
comparing the parsed previous communications against the user submitted inquiry; or
creating a new conversation when the submitted inquiry is unrelated to any previous communication;
initiating a form filing process to complete the one or more form fields when a previous communication relevant to the user inquiry is found.

17. The system of claim 15, wherein the set of instructions are further configured to cause the at least one processor to execute:
retrieving a collection of service items from a search system;
prompting a relevance identification module to identify a relevant service item based on the user inquiry or submit follow-up questions to the user to identify the user's intent of the user inquiry;
based on the response received from identification module; passing the received response to a Logistic Regression model to output a value;
based on the outputted value, performing slot filling of one or more form fields in the service item form or submit a simple response to the user prompting termination of the service item form filling, or submit two or more relevant service items for the user to select from in order to complete the service item form filling.

18. The system of claim 15, wherein the set of instructions are further configured to cause the at least one processor to execute:
identifying when the user has previously provided any information related to the relevant service item; and
completing or inserting in values associated with the service items in one or more form fields of the service item form prior to requesting the user to insert one or more values into one or more form fields.

19. The system of claim 15, wherein the set of instructions are further configured to cause the at least one processor to execute:
continuously conversing or communicating with the user until the user is guided towards an answer, wherein the continuously conversing or communicating comprises
upon receiving an answer from the user, evaluating whether the user has answered the inquiry, and
when the user answered a question, validating one or more form field values against one or more desired types, and filing the one or more form fields with required data.

20. The system of claim 15, wherein the set of instructions are further configured to cause the at least one processor to execute:
validating one or more values in the one or more form fields against one or more desired types;
once the one or more form fields are validated, displaying the one or more form fields to the user for confirmation; and
upon confirmation receipt, receiving the submitted form,
receiving a request from the user to edit the one or more form fields, or
when the user denied the validation, redirecting the user to a portal with the form pre-populated with values extracted during the conversation.
